(19) United States
(12) Patent Application Publication
(10) Pub. No.: US 2023/0071267 A1
(43) Pub. Date: Mar. 9, 2023

(54) CHARGING SYSTEM AND CHARGING STATION

(71) Applicant: IHI CORPORATION, Tokyo (JP)

(72) Inventors: Eiichiro FUJIWARA, Tokyo (JP); Masao ONO, Tokyo (JP)

(73) Assignee: IHI CORPORATION, Tokyo (JP)

(21) Appl. No.: 18/049,387

(22) Filed: Oct. 25, 2022

Related U.S. Application Data
(63) Continuation of application No. PCT/JP2021/021768, filed on Jun. 8, 2021.

(30) Foreign Application Priority Data
Jun. 29, 2020 (JP) 2020-111320

(51) Int. Cl. B60L 53/64; H02J 7/00; G06Q 50/06; G06Q 30/02; B60L 50/60; B60L 53/67

(52) U.S. Cl. CPC B60L 53/64; H02J 7/0071; G06Q 50/06; G06Q 30/0206; G06Q 30/0234; B60L 50/60; B60L 53/67

(57) ABSTRACT

Provided is a charging system (1) including: one or a plurality of charging stations (10); and a host unit (16) configured to hold communication to and from the charging stations (10), wherein each of the charging stations (10) includes: a plurality of chargers (30) configured to charge batteries (20) mounted to vehicles (12); and a charging control module (42) configured to control charging by the chargers (30) in accordance with a charging schedule, wherein the host unit (16) includes a schedule management module (70) configured to create the charging schedule, and wherein the schedule management module (70) is configured to create the charging schedule in which at least part of a future electric power charge amount planned to be allocated to some of the vehicles (12) that are presently being charged is cut down to be allocated to charging for one of the vehicles (12) that requests early start of charging.

### CROSS REFERENCE TO RELATED APPLICATIONS

This application is a continuation application of International Application No. PCT/JP2021/021768, filed on Jun. 8, 2021, which claims the benefit of priority to Japanese Patent Application No. 2020-111320 filed on Jun. 29, 2020, and contents thereof are incorporated herein.

### BACKGROUND ART

### Technical Field

The present disclosure relates to a charging system and a charging station which are capable of charging a battery of a vehicle.

For example, in Patent Literature 1, there is disclosed a method in which a lack of registration of a predetermined charging act in a charging schedule is notified to an in-vehicle device by an EV management center.

### CITATION LIST

### Patent Literature

Patent Literature 1: Japanese Patent No. 6539903 B2

### SUMMARY

### Technical Problem

Charging at a charging station is generally started in order from vehicles that request charging. Consequently, depending on timing at which charging is newly requested, charging starts late and may not be finished within a time desired by a driver.

An object of the present disclosure is to provide a charging system and a charging station which are capable of finishing charging early.

### Solution to Problem

In order to solve the above-mentioned problem, according to one aspect of the present disclosure, there is provided a charging system including: one or a plurality of charging stations; and a host unit configured to hold communication to and from the one or the plurality of charging stations, wherein each of the one or the plurality of charging stations includes: a plurality of chargers configured to charge batteries mounted to vehicles; and a charging control module configured to control charging by the plurality of chargers in accordance with a charging schedule, wherein the host unit includes a schedule management module configured to create the charging schedule, and wherein the schedule management module is configured to create the charging schedule in which at least part of a future electric power charge amount planned to be allocated to some of the vehicles that are presently being charged is cut down to be allocated to charging for one of the vehicles that requests early start of charging.

Further, the schedule management module may be configured to: demand the one of the vehicles that requests early start of charging to pay a price required to benefit from the early start of charging; and present the some of the vehicles for which the future electric power charge amount is cut down with a compensation for inconveniences caused by the cutting down of the electric power charge amount.

In order to solve the above-mentioned problem, according to another aspect of the present disclosure, there is provided a charging station including: a plurality of chargers configured to charge batteries mounted to vehicles; a charging control module configured to control charging by the plurality of chargers in accordance with a charging schedule; and a schedule management module configured to create the charging schedule, wherein the schedule management module is configured to create the charging schedule in which at least part of a future electric power charge amount planned to be allocated to some of the vehicles that are presently being charged is cut down to be allocated to charging for one of the vehicles that requests early start of charging.

### Effects of Disclosure

According to the present disclosure, it is possible to finish charging early.

### BRIEF DESCRIPTION OF DRAWINGS

FIG. 1 is a schematic diagram for illustrating a configuration of a charging system according to a first embodiment of the present disclosure.

FIG. 2 is a group of graphs for showing an outline of operation of a schedule management module.

FIG. 3 is a group of graphs for showing an example of how early charging is accomplished.

FIG. 4 is a diagram for illustrating a rough flow of overall operation of the charging system.

FIG. 5 is a flow chart for illustrating a detailed flow of operation in the schedule management module.

FIG. 6 is a flow chart for illustrating a flow of special charging schedule creation processing.

FIG. 7 is a schematic diagram for illustrating a configuration of a charging system according to a second embodiment of the present disclosure.

### DESCRIPTION OF EMBODIMENTS

Now, with reference to the attached drawings, embodiments of the present disclosure are described in detail. The dimensions, materials, and other specific numerical values represented in the embodiments are merely examples used for facilitating the understanding of the disclosure, and do not limit the present disclosure otherwise particularly noted. Elements having substantially the same functions and configurations herein and in the drawings are denoted by the same reference symbols to omit redundant description thereof. Further, illustration of elements with no direct relationship to the present disclosure is omitted.

### First Embodiment

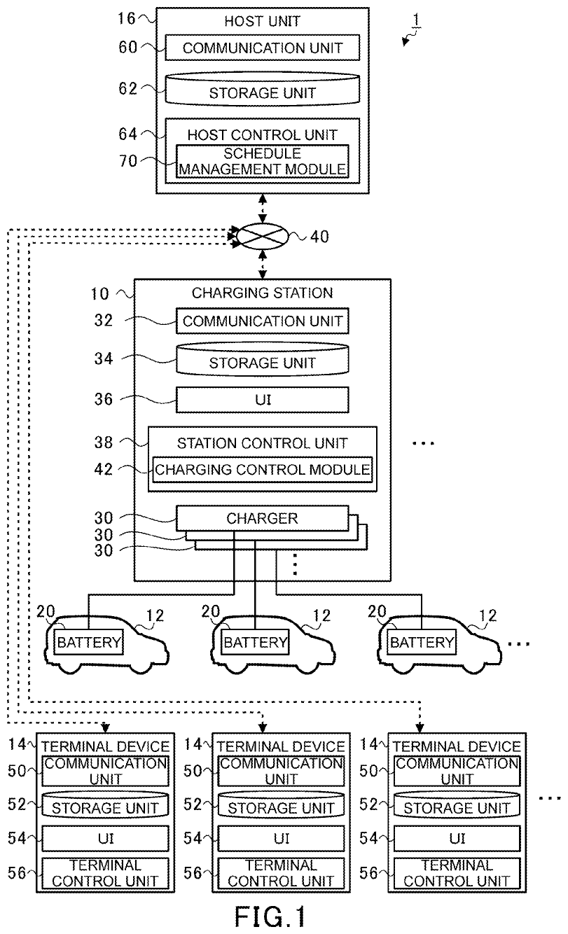

FIG. 1 is a schematic diagram for illustrating a configuration of a charging system 1 according to a first embodiment of the present disclosure. The charging system 1 includes a charging station 10, vehicles 12, terminal devices 14, and a host unit 16. In FIG. 1, for convenience of description, one charging station is illustrated as an example. The number of charging stations is not limited to one, and may be two or more.

The vehicles 12 are electric vehicles, hybrid vehicles, or the like mounted with batteries 20 which supply electric power to a drive source. The vehicles 12 that are electric vehicles, hybrid vehicles, or the like may be hereinafter sometimes referred to as “EVs”. In FIG. 1, three vehicles 12 are illustrated as an example. However, the number of the vehicles 12 is not limited to three, and is only required to be more than one. Accordingly, there may be two vehicles 12 or four or more vehicles 12.

A plurality of chargers 30 are installed at the charging station 10. In FIG. 1, three chargers 30 are illustrated as an example. However, the number of the chargers 30 is not limited to three, and is only required to be more than one. Accordingly, there may be two chargers 30 or four or more chargers 30. The chargers 30 are connected to, for example, an electric power system (not shown). The chargers 30 are capable of converting electric power of the electric power system and supply the converted power to the batteries 20 of the vehicles 12. That is, the charging station 10 is a so-called EV power station, and is capable of charging the batteries 20 of the vehicles 12. The following description may use “charging of the vehicles 12” as a shortened expression of “charging of” the batteries 20 of the vehicles 12.

The charging station 10 includes, in addition to the chargers 30, a communication unit 32, a storage unit 34, a user interface 36, and a station control unit 38. In FIG. 1, the user interface 36 is abbreviated as “UI.”

The communication unit 32 is connected to a communication network 40 by wired connection or wireless connection. The communication unit 32 is capable of establishing communication to and from the host unit 16 and communication to and from the terminal devices 14 through the communication network 40. The storage unit 34 is configured from, for example, a non-volatile storage device. The storage unit 34 stores, for example, various types of information used in the charging station 10. The user interface 36 has an input function in the form of, for example, a touch panel. The input function receives input operation of users (for example, drivers of the vehicles 12). The user interface 36 also has an output function in the form of, for example, a display. The output function presents various types of information to the users.

The station control unit 38 is formed of a semiconductor integrated circuit including a central processing unit (CPU), a ROM in which a program and the like are stored, a RAM being a work area, and the like. The station control unit 38 functions as a charging control module 42 by executing a program.

As described later, a charging schedule is created in the charging system 1. In the charging schedule, various types of information about charging of the vehicles 12 by the chargers 30 are defined. Examples of the various types of information about charging include a charging start time (a scheduled charging start time), a charging end time (a scheduled charging end time), a charging duration, an electric power charge amount, vehicle identifiers for identifying the vehicles 12, and utilization states of the chargers 30 or reservation states of the chargers 30.

The charging control module 42 controls charging of the batteries 20 by the chargers 30 in accordance with the created charging schedule. For example, when the current time reaches a predetermined charging start time of one of the vehicles 12, the charging control module 42 causes one of the chargers 30 to start supply of electric power to the one of the vehicles 12. When the current time reaches a predetermined charging end time of one of the vehicles 12, the charging control module 42 causes the relevant charger out of the chargers 30 to end supply of electric power to the one of the vehicles 12. The charging control module 42 is described later in detail.

The terminal devices 14 are portable communication devices, for example, smartphones or tablet computers. In FIG. 1, three terminal devices 14 are illustrated as an example. However, the number of the terminal devices 14 is not limited to three, and is only required to be more than one. Accordingly, there may be two terminal devices 14 or four or more terminal devices 14. For example, the number of the terminal devices 14 is the same as the number of the vehicles 12. Specifically, the terminal devices 14 are carried around by drivers of the vehicles 12. That is, each of the terminal devices 14 individually corresponds to one of the vehicles 12.

Each of the terminal devices 14 includes a communication unit 50, a storage unit 52, a user interface 54, and a terminal control unit 56. In FIG. 1, the user interface 54 is abbreviated as “UI.”

The communication unit 50 is connected to the communication network 40 by wired connection or wireless connection. The communication unit 50 is capable of establishing communication to and from the host unit 16 and communication to and from the charging station 10 through the communication network 40. Each of the terminal devices 14 may be capable of holding communication to and from one of the vehicles 12 that corresponds to the terminal device 14 (one of the vehicles 12 that is driven by a driver who carries the terminal device 14 around).

The storage unit 52 is configured from, for example, a non-volatile storage device. The storage unit 52 stores, for example, various types of information used in the terminal device 14. The user interface 54 has an input function in the form of, for example, a touch panel. The input function receives input operation of users (for example, drivers of the vehicles 12). The user interface 54 also has an output function in the form of, for example, a display. The output function presents various types of information to the users.

The terminal control unit 56 is formed of a semiconductor integrated circuit including a central processing unit (CPU), a ROM in which a program and the like are stored, a RAM being a work area, and the like. The terminal control unit 56 performs overall control of its own terminal device out of the terminal devices 14 by executing a program.

The host unit 16 is installed by, for example, a business organization that provides a management service, an information processing service, or a similar service regarding the charging station 10. The host unit 16 includes a communication unit 60, a storage unit 62, and a host control unit 64.

The communication unit 60 is connected to the communication network 40 by wired connection or wireless connection. The communication unit 60 is capable of establishing communication to and from the charging station 10 and communication to and from the terminal devices 14 through the communication network 40. The storage unit 62 is configured from, for example, a non-volatile storage device. The storage unit 62 stores, for example, various types of information used in the host unit 16.

The host control unit 64 is formed of a semiconductor integrated circuit including a central processing unit (CPU), a ROM in which a program and the like are stored, a RAM being a work area, and the like. The host control unit 64 functions as a schedule management module 70 by executing a program.

The schedule management module 70 creates a charging schedule using the chargers 30 at the charging station 10. The schedule management module 70 updates the charging schedule each time a request for charging (reservation of charging) is newly received from one of the terminal devices 14 (in other words, the vehicles 12). The schedule management module 70 transmits the created charging schedule to the charging station 10. The charging control module 42 of the charging station 10 executes charging of the vehicles 12 by the chargers 30 based on the received charging schedule. The schedule management module 70 is described later in detail.

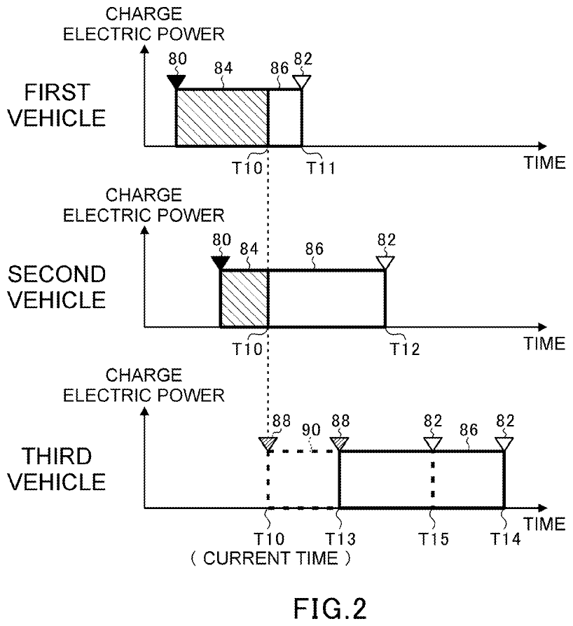

FIG. 2 is a group of graphs for showing an outline of operation of the schedule management module 70. In FIG. 2, an example in which there are three vehicles 12 referred to as “first vehicle,” “second vehicle,” and “third vehicle” is shown. In FIG. 2, a time T10 is the current time. The first vehicle and the second vehicle are presently being charged at the charging station 10. In FIG. 2, a black triangle 80 indicates a charging start time. An outlined white triangle 82 indicates a scheduled charging end time. For example, a time T11 is a scheduled charging end time of the first vehicle, and a time T12 is a charging end time of the second vehicle. A hatched quadrangle 84 indicates an electric power charge amount that has been charged. An outlined white quadrangle 86 indicates a remaining (uncharged) electric power charge amount to be charged in a period from the current time to the scheduled charging end time. In this state, the third vehicle newly requests charging. In FIG. 2, a hatched triangle 88 indicates a scheduled charging start time.

For example, when immediate start of charging of the third vehicle may cause power consumption in the charging station 10 to exceed a contract amount of electric power, the schedule management module 70 creates a charging schedule so that the power consumption in the charging station 10 is less than the contract amount of electric power. This sets the scheduled charging start time of the third vehicle to a time beyond the current time, for example, a time T13. Then, the scheduled charging end time of the third vehicle is, for example, a time T14.

However, the driver of the third vehicle may want to finish charging earlier than the time T14 even when it means an extra charging cost.

In view of this, in this case, the one of the vehicles 12 that is to be newly charged (the third vehicle) issues a request for early execution of charging (hereinafter may be referred to as “early charging”) to the host unit 16. When there is a request for early charging from the one of the vehicles 12 that is to be newly charged, the schedule management module 70 moves the scheduled charging start time of the one of the vehicles 12 ahead of the initial scheduled charging start time. For example, as indicated by a broken line quadrangle 90 of FIG. 2, the scheduled charging start time of the third vehicle is moved up from the time T13 to the time T10 (the current time). This allows the scheduled charging end time of the third vehicle to be moved up from the time T14 to a time T15.

However, simple moving up of the scheduled charging start time of the third vehicle may not be enough to prevent power consumption in the charging station 10 from exceeding the contract amount of electric power.

The schedule management module 70 accordingly accomplishes early charging in the third vehicle by allocating part of or all of a future electric power charge amount planned to be allocated to the first vehicle and the second vehicle which are presently being charged to the third vehicle.

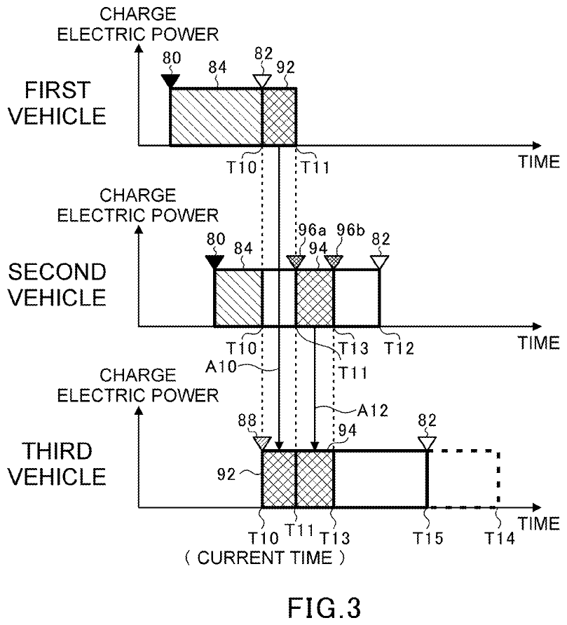

FIG. 3 is a group of graphs for showing an example of how early charging is accomplished. In FIG. 3, at the current time (the time T10), the first vehicle and the second vehicle are being charged, and the third vehicle has newly requested early charging.

For example, a planned state of charge (SOC) that is an SOC of each of the batteries 20 at the end of charging is set in advance, prior to the start of charging. For example, in a case of full charging, the planned SOC is set to 100%.

It is assumed here that the drivers of the first vehicle and the second vehicle have consented to a possible decrease of the SOC at the end of charging from the planned SOC set before the start of charging. An index for whether a decrease of the SOC at the end of charging from the planned SOC is tolerable may be hereinafter referred to as “SOC reduction permission.” That is, the schedule management module 70 has acquired confirmation on approval of the SOC reduction permission from the drivers of the first vehicle and the second vehicle.

It is also assumed that the drivers of the first vehicle and the second vehicle have clearly specified what degree of decrease of the SOC at the end of charging is acceptable. An index for the tolerable degree of decrease of the SOC at the end of charging may be hereinafter referred to as “tolerable SOC reduction.” That is, the schedule management module 70 has acquired information about the tolerable SOC reduction from the drivers of the first vehicle and the second vehicle.

The tolerable SOC reduction is indicated by a reduction amount based on the planned SOC, for example, a reduction of 30% at maximum. Alternatively, the tolerable SOC reduction may be indicated by the SOC at the end of charging itself, for example, an SOC of 70% or more at the end of charging.

The SOC reduction permission and the tolerable SOC reduction are acquired through the terminal devices 14 carried around by the drivers of the first vehicle and the second vehicle. The SOC reduction permission and the tolerable SOC reduction may also be acquired directly from the first vehicle and the second vehicle.

For example, it is assumed that, in a case of the first vehicle, the planned SOC is 100%, an SOC of 70% or more is acceptable for a condition to stop charging, and the current SOC is 80%. In this example, charging of the first vehicle can be stopped at the current time. The schedule management module 70 accordingly moves up the scheduled charging end time of the first vehicle from the initial time T11 to the current time (the time T10) as indicated by the outlined white triangle 82 of FIG. 3.

This creates, as indicated by a cross-hatched quadrangle 92 of FIG. 3, an excess (an SOC of 20%=100%-80%) of a future electric power charge amount that has been planned to be allocated to charging of the first vehicle. The schedule management module 70 allocates the excess electric power charge amount for the first vehicle to charging of the third vehicle as indicated by an arrow A10 of FIG. 3. The third vehicle can thus be charged in a period from the current time (T10) to the time T11.

It is also assumed that, in a case of the second vehicle, the planned SOC is 100%, an SOC of 70% or more is acceptable for a condition to stop charging, and the current SOC is 40%. In this example, an excess electric power charge amount that is an SOC of 30% (100%-70%) at maximum can be created out of an electric power charge amount planned to be allocated to charging of the second vehicle from the current time onward.

As indicated by a cross-hatched quadrangle 94 of FIG. 3, there is a shortage of an electric power charge amount for the third vehicle in a period from the time T11 to the time T13. It is assumed that the shortage (for example, an electric power charge amount corresponding to an SOC of 20%) is less than the excess electric power charge amount (corresponding to an SOC of 30%) for the second vehicle.

Charging in the second vehicle is accordingly suspended for a period from the time T11 to the time T13. Specifically, at the time T11 indicated by a cross-hatched triangle 96a, supply of electric power to the second vehicle is suspended. Subsequently, at the time T13 indicated by a cross-hatched triangle 96b, supply of electric power to the second vehicle is resumed. This creates an excess electric power charge amount in the second vehicle as indicated by the cross-hatched quadrangle 94 of FIG. 3. The schedule management module 70 allocates the excess future electric power charge amount for the second vehicle to the charging of the third vehicle in a period from the time T11 to the time T13 as indicated by an arrow A12 of FIG. 3. The third vehicle can thus be charged in the period from the time T11 to the time T13.

In this manner, the third vehicle can secure an electric power charge amount for charging until the time T13, which is the initial scheduled charging start time. The scheduled charging start time of the third vehicle can thus be brought forward to the current time (the time T10). The scheduled charging end time of the third vehicle can consequently be brought forward to the time T15, which is earlier than the initial scheduled charging end time (the time T14).

To summarize, when early charging is requested, the schedule management module 70 cuts down the SOC at the end of charging to less than the planned SOC set before the start of charging with respect to each of the vehicles 12 that is presently being charged. That is, the schedule management module 70 cuts at least part of an electric power charge amount that has been planned to be allocated to the vehicles presently being charged. At the same time, the schedule management module 70 allocates an excess future electric power charge amount created by the reduction of the SOC (electric power charge amount) to charging of one of the vehicles 12 that has requested early start of charging. The schedule management module 70 creates a charging schedule in which charging is scheduled in the manner described above. A charging schedule in which charging is scheduled in the manner described above may be hereinafter referred to as “special charging schedule” for the convenience of description.

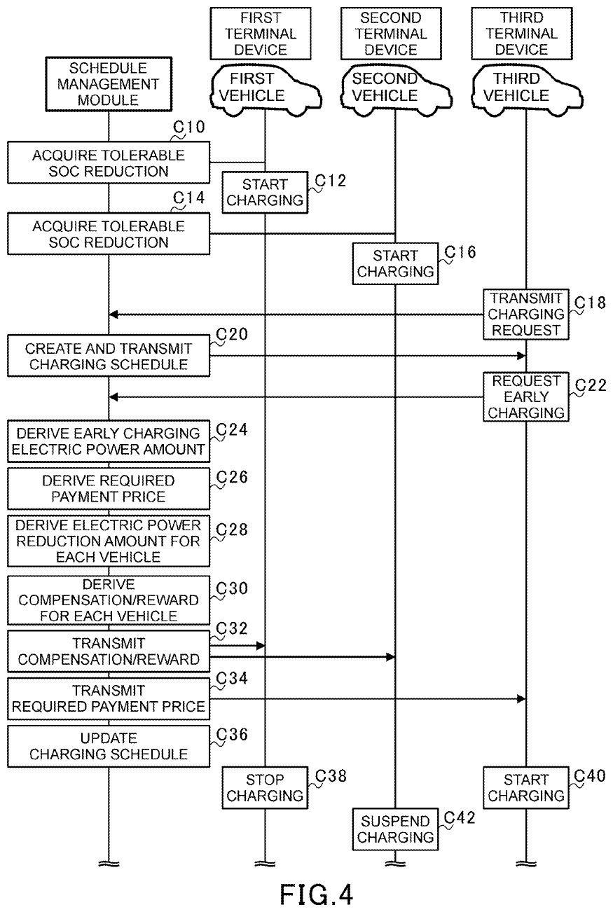

FIG. 4 is a diagram for illustrating a rough flow of overall operation of the charging system 1. In FIG. 4, the first vehicle, the second vehicle, and the third vehicle are illustrated as an example as in FIG. 2 and FIG. 3. In FIG. 4, three terminal devices 14, which are a first terminal device, a second terminal device, and a third terminal device, are illustrated as an example. In FIG. 4, the first vehicle corresponds to the first terminal device, the second vehicle corresponds to the second terminal device, and the third vehicle corresponds to the third terminal device.

When the first vehicle transmits a charging request to the schedule management module 70, the schedule management module 70 acquires the tolerable SOC reduction from the first vehicle (C10). The schedule management module 70 then creates the latest charging schedule, and charging of the first vehicle is started in accordance with the latest charging schedule (C12). When the second vehicle transmits a charging request to the schedule management module 70, the schedule management module 70 acquires the tolerable SOC reduction from the second vehicle (C14). The schedule management module 70 then creates the latest charging schedule, and charging of the second vehicle is started in accordance with the latest charging schedule (C16).

In a period in which the first vehicle and the second vehicle are being charged, the third terminal device (third vehicle) transmits a charging request to the schedule management module 70 in order to newly start charging (C18).

The schedule management module 70 creates a new charging schedule including charging of the third vehicle, taking the current charging schedule into consideration, and transmits the new charging schedule to the third terminal device (third vehicle) (C20). The driver of the third vehicle is unsatisfied with the presented charging schedule, and issues a request for early start of charging through the third terminal device (third vehicle) to the schedule management module 70 (C22).

It is assumed here that, in the charging system 1, a person who requests early start of charging (for example, the driver of the third vehicle) additionally pays a price for early charging, in addition to a charging fee for normal charging. That is, payment of a price required to benefit from early start of charging is demanded of one of the vehicles 12 (one of the terminal devices 14) that requests early start of charging. The required price is monetary, for example, an extra (increased amount of) charging fee. Payment of the required price is not limited to monetary payment, and can be set suitably. A required price to be paid may be hereinafter referred to as “required payment price.”

Conversely, the charging system 1 rewards a person who cooperates in cutting down of the future electric power charge amount (for example, the driver of the first vehicle and the driver of the second vehicle) for cooperation. That is, each of the vehicles 12 (each of the terminal devices 14) for which the future electric power charge amount is cut down is presented a compensation for inconveniences caused by the cutting down of the electric power charge amount. The compensation is monetary, for example, a discounted (a decreased amount of) charging fee. The compensation is not limited to a monetary compensation, and can be set suitably. The compensation may be hereinafter referred to as “compensation/reward.”

The special charging schedule can smoothly be implemented by thus giving the compensation/reward to a cooperator and obliging a person who requests early charging to pay the required payment price.

When a request for early charging is received, the schedule management module 70 derives an early charging electric power amount for the third vehicle (C24). The early charging electric power amount indicates an electric power charge amount for charging moved ahead. To describe in more detail, the early charging electric power amount indicates an electric power charge amount in a period from the current time to the initial scheduled charging start time in the vehicle that has requested early charging (the third vehicle). The schedule management module 70 derives the required payment price based on the early charging electric power amount (C26). For example, the schedule management module 70 may gradually increase the required payment price with an increase in early charging electric power amount.

The schedule management module 70 also derives, for each of the vehicles 12 for which the SOC at the end of charging is cut down (hereinafter may be referred to as “reduction target vehicle”), an electric power reduction amount (C28). The schedule management module 70 derives the electric power reduction amount of each of the vehicles 12 by referring to, for example, the tolerable SOC reduction of each of the vehicles 12, the early charging electric power amount, and the current charging schedule. The electric power reduction amount indicates an electric power charge amount to be cut down out of the future electric power charge amount planned to be used for the reduction target vehicle. The schedule management module 70 derives the compensation/reward of each of the vehicles 12 based on the electric power reduction amount of each of the vehicles 12 (C30). For example, the schedule management module 70 may gradually increase the compensation/reward with an increase in electric power reduction amount.

The schedule management module 70 transmits the derived compensation/reward to each of the first vehicle and the second vehicle (C32), and transmits the derived required payment price to the third vehicle (C34). The schedule management module 70 then updates the charging schedule (C36). Charging of the first vehicle is consequently stopped earlier than the initial scheduled charging end time (C38). With the early stop, charging of the third vehicle is started earlier than the initial scheduled charging start time (C40). When the initial scheduled charging end time of the first vehicle arrives, charging of the second vehicle is suspended (C42). During the suspension, charging of the third vehicle is continued. As a result, charging of the third vehicle is finished earlier than the initial charging end time.

The description given above with reference to FIG. 4 is about a rough flow of the overall operation of the charging system 1. Detailed operation of the schedule management module 70 is described next by focusing on the schedule management module 70.

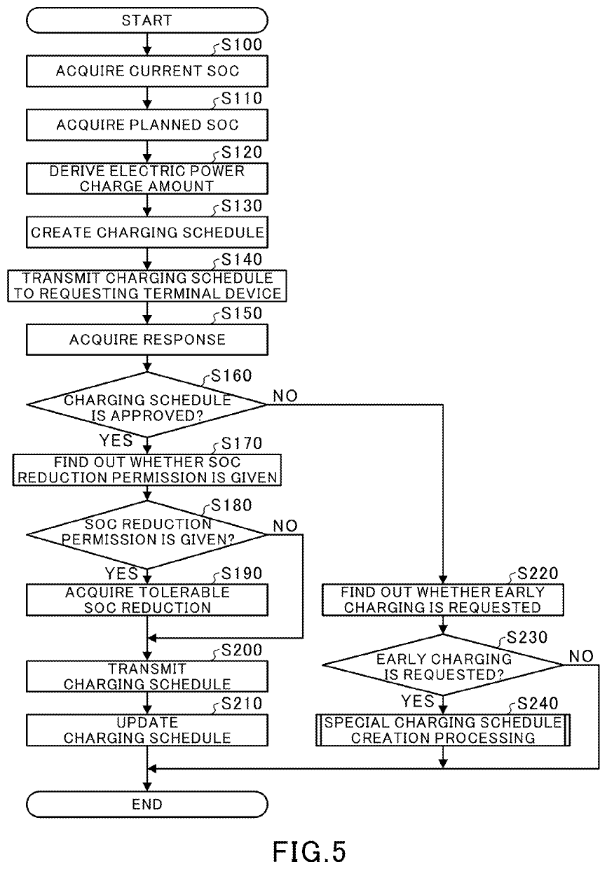

FIG. 5 is a flow chart for illustrating a detailed flow of operation in the schedule management module 70. For example, a driver of one of the vehicles 12 issues a charging request (charging reservation) to charge the one of the vehicles 12 via the user interface 54 of the corresponding one of the terminal devices 14. The schedule management module 70 receives the charging request over the communication network 40, and starts a series of processing steps of FIG. 5. The one of the terminal devices 14 and the one of the vehicles 12 that have issued the charging request may be hereinafter referred to as “requesting terminal device” and “requesting vehicle.”

The schedule management module 70 first acquires the current SOC of one of the batteries 20 that is in the requesting vehicle (Step S100). For example, the schedule management module 70 acquires the current SOC of the requesting vehicle through the requesting terminal device. The schedule management module 70 may identify the requesting vehicle from the requesting terminal device to acquire the current SOC directly from the identified requesting vehicle.

The schedule management module 70 next acquires a planned SOC desired by the driver through the requesting terminal device (Step S110). For example, when full charging is desired, the planned SOC is 100%. The schedule management module 70 next derives an electric power charge amount required to reach the planned SOC from the current SOC (Step S120).

The schedule management module 70 next creates a charging schedule based on the derived electric power charge amount (Step S130). Here, the schedule management module 70 creates a new charging schedule for an assumed case in which charging of the requesting vehicle is newly executed, taking into consideration the state of the current charging schedule. The new charging schedule includes a scheduled charging start time and a scheduled charging end time of the requesting vehicle.

The schedule management module 70 next transmits the derived new charging schedule to the requesting terminal device (Step S140). The requesting terminal device thus receives, as a result of the charging request, a charging schedule including a scheduled charging start time and a scheduled charging end time.

The requesting terminal device presents, through the user interface 54, the charging schedule (the scheduled charging start time and the scheduled charging end time) to the driver. The driver inputs, through the user interface 54, whether the driver approves the presented charging schedule. The requesting terminal device transmits a result of the input about whether the driver approves the charging schedule, as a response to the host unit 16 through the communication unit 50. The schedule management module 70 thus acquires the response from the requesting terminal device (Step S150).

Once acquiring the response, the schedule management module 70 determines whether the response is an approval of the charging schedule (Step S160).

When the response is an approval of the charging schedule (“YES” in Step S160), the schedule management module 70 finds out whether the SOC reduction permission is given (Step S170). For example, the schedule management module 70 issues an inquiry about whether the SOC reduction permission is given to the requesting terminal device. The requesting terminal device prompts the driver to input whether the driver gives the SOC reduction permission, and transmits a result of the input to the schedule management module 70. Whether the SOC reduction permission is given is stored in association with the requesting vehicle.

When the SOC reduction permission is given (“YES” in Step S180), the schedule management module 70 acquires the tolerable SOC reduction (Step S190). For example, the schedule management module 70 issues an inquiry about the tolerable SOC reduction to the requesting terminal device. The requesting terminal device prompts the driver to input the tolerable SOC reduction, and transmits a result of the input to the schedule management module 70. When the SOC reduction permission is not given (“NO” in Step S180), on the other hand, the schedule management module 70 does not execute the processing step of Step S190.

With the charging schedule approved in Step S160, the schedule management module 70 next transmits the charging schedule created in Step S130 to the charging station 10 (Step S200). The schedule management module 70 then updates the created charging schedule with the latest charging schedule (Step S210), and ends the series of processing steps. Further, the charging station 10 receives the charging schedule and updates the received charging schedule with the latest charging schedule. Charging in accordance with the latest charging schedule is thus executed.

When the response is not an approval of the charging schedule in Step S160 (“NO” in Step S160), the schedule management module 70 finds out whether early charging is requested. For example, the schedule management module 70 issues an inquiry about whether early charging is requested to the requesting terminal device. The requesting terminal device prompts the driver to input whether the driver requests early charging, and transmits a result of the input to the schedule management module 70.

When early charging is requested (“YES” in Step S230), the schedule management module 70 executes special charging schedule creation processing (Step S240), and ends the series of processing steps. The special charging schedule creation processing is described later in detail.

When early charging is not requested (“NO” in Step S230), the schedule management module 70 ends the series of processing steps without executing Step S240. In this case, the charging schedule created in Step S130 is discarded, and the current charging schedule is maintained.

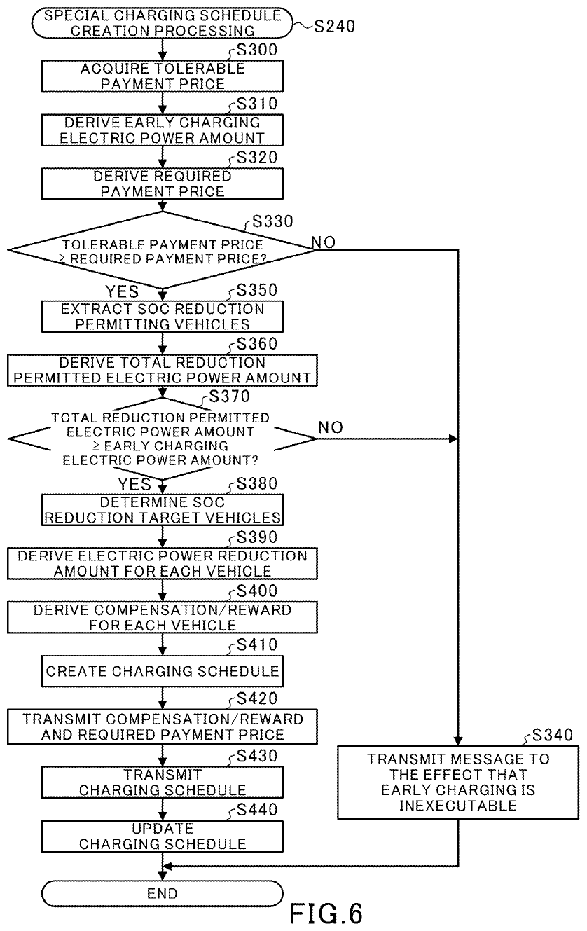

FIG. 6 is a flow chart for illustrating a flow of the special charging schedule creation processing. The schedule management module 70 first acquires a tolerable payment price from the requesting terminal device (Step S300). The tolerable payment price indicates a maximum value of a price tolerable for the driver to pay in order to benefit from early start of charging. For example, the schedule management module 70 issues an inquiry about the tolerable payment price to the requesting terminal device. The requesting terminal device prompts the driver to input the tolerable payment price, and transmits a result of the input to the schedule management module 70.

The schedule management module 70 next refers to the charging schedule (the initial charging schedule) derived in Step S130, and derives a move-ahead time by subtracting the current time from the scheduled charging start time of the requesting vehicle. The schedule management module 70 then derives the early charging electric power amount based on the move-ahead time (Step S310). The schedule management module 70 next derives the required payment price based on the early charging electric power amount (Step S320).

The schedule management module 70 next determines whether the amount (the absolute value) of the tolerable payment price is equal to or more than the amount (absolute value) of the required payment price (Step S330). When the tolerable payment price is less than the required payment price (“NO” in Step S330), the schedule management module 70 transmits a message to the effect that early charging is inexecutable to the requesting terminal device (Step S340), and ends the series of processing steps.

When the tolerable payment price is equal to or more than the required payment price (“YES” in Step S330), the schedule management module 70 extracts SOC reduction permitting vehicles from the vehicles 12 that are presently being charged (Step S350). The schedule management module 70 next adds up the tolerable SOC reductions of the extracted SOC reduction permitting vehicles, to thereby derive a total reduction permitted electric power amount (Step S360).

The schedule management module 70 next determines whether the total reduction permitted electric power amount is equal to or more than the early charging electric power amount (Step S370). When the total reduction permitted electric power amount is less than the early charging electric power amount (“NO” in Step S370), the schedule management module 70 transmits a message to the effect that early charging is inexecutable to the requesting terminal device (Step S340), and ends the series of processing steps.

When the total reduction permitted electric power amount is equal to or more than the early charging electric power amount (“YES” in Step S370), the schedule management module 70 determines SOC reduction target vehicles (Step S380). Specifically, the schedule management module 70 determines SOC reduction target vehicles from among the extracted SOC reduction permitting vehicles, in a predetermined priority order. The predetermined priority order is, for example, an order of proximity of the scheduled charging end time to the present. The predetermined priority order is not limited to this example, and can be set to any order. The schedule management module 70 adds the tolerable SOC reductions in descending order of priority of the SOC reduction permitting vehicles until the value of the addition reaches the early charging electric power amount or more, and determines the SOC reduction permitting vehicles that have the tolerable SOC reductions used in the addition as the SOC reduction target vehicles.

The schedule management module 70 next derives, for each of the SOC reduction target vehicles, an electric power reduction amount based on the tolerable SOC reduction (Step S390). The schedule management module 70 next derives the compensation/reward for each of the SOC reduction target vehicles based on the electric power reduction amount of each of the SOC reduction target vehicles (Step S400).

The schedule management module 70 next creates a charging schedule (special charging schedule) in which the SOC at the end of charging is cut down for each of the SOC reduction target vehicles based on the electric power reduction amount, and the scheduled charging start time of the requesting vehicle is moved ahead (Step S410).

The schedule management module 70 next transmits, to each of the terminal devices 14 corresponding to the SOC reduction target vehicles, information about the compensation/reward derived in Step S400 (Step S420). Each of the terminal devices 14 corresponding to the SOC reduction target vehicles presents the received information about the compensation/reward to the driver through the user interface 54.

In parallel, the schedule management module 70 transmits information about the required payment price derived in Step S320 to the requesting terminal device (Step S420). The requesting terminal device presents the received information about the required payment price to the driver through the user interface 54.

The schedule management module 70 next transmits the charging schedule (special charging schedule) created in Step S410 to the charging station 10 (Step S430). The schedule management module 70 then updates the charging schedule with the charging schedule created in Step S410 (Step S440), and ends the series of processing steps. Further, the charging station 10 receives the charging schedule, and updates the charging schedule with the received charging schedule. The scheduled charging start time of the requesting vehicle is thus moved ahead, compared to the initial charging schedule.

As described above, the schedule management module 70 of the charging system 1 of the first embodiment creates a charging schedule in which at least part of a future electric power charge amount that has been planned to be allocated to the vehicles 12 presently being charged is cut down, and allocated to charging of one of the vehicles 12 that requests early start of charging.

This enables the charging system 1 of the first embodiment to finish charging of the one of the vehicles 12 early, with a power consumption amount at the charging station 10 kept from increasing.

The schedule management module 70 of the charging system 1 of the first embodiment demands the required payment price from one of the vehicles 12 that requests early start of charging, and presents the compensation/reward to the vehicles 12 that are reduced in future electric power charge amount.

The charging system 1 of the first embodiment can accordingly alleviate complaints of both of the vehicles 12 that request early start of charging and the vehicles 12 for which the future electric power charge amount is reduced. As a result, the charging system 1 of the first embodiment can smoothly re-allocate the electric power charge amount between the vehicles 12 that request early start of charging and the vehicles 12 for which the future electric power charge amount is reduced.

In the first embodiment, a mode in which the charging schedule of one charging station 10 is created by the schedule management module 70 of the host unit 16 has been described. However, the schedule management module 70 may create charging schedules of more than one charging station 10 in parallel.

The tightness of the charging schedule may vary among more than one charging station 10. In this case, the schedule management module 70 of the host unit 16 may lead the vehicles 12 to be newly charged to the charging station 10 that is uncrowded. This prevents issuing of an excessively large number of requests for early charging.

The schedule management module 70 acquires the tolerable SOC reduction from each SOC reduction permitting vehicle. However, the schedule management module 70 may acquire, in addition to the tolerable SOC reduction, for example, a lower limit value of a compensation (requested compensation/reward) requested by the driver to be received for cutting down of the electric power charge amount. For example, the schedule management module 70 may set an SOC reduction permitting vehicle as an SOC reduction target vehicle only when the tolerable SOC reduction condition is satisfied and the amount (absolute value) of the obtained compensation is equal to or more than the amount (absolute value) of the requested compensation/reward.

### Second Embodiment

In the first embodiment, the schedule management module 70 is provided in the host unit 16. However, the schedule management module 70 is not limited to the mode in which the schedule management module 70 is provided in the host unit 16.

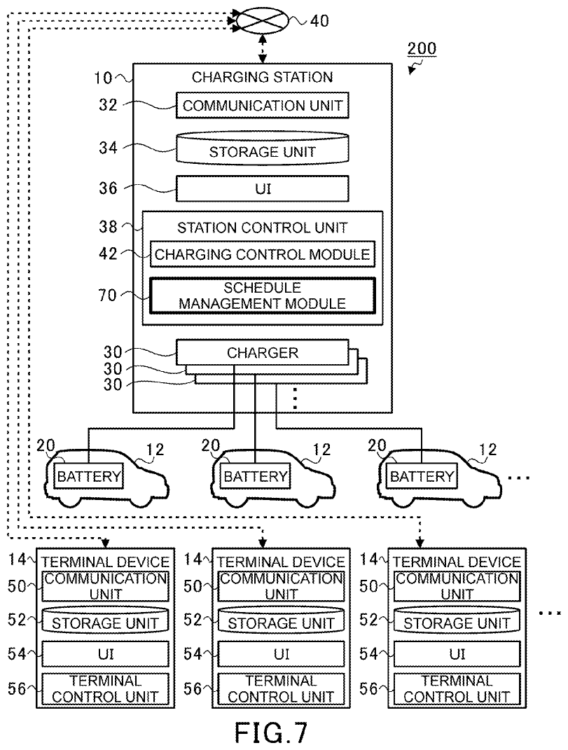

FIG. 7 is a schematic diagram for illustrating a configuration of a charging system 200 according to a second embodiment of the present disclosure. In the charging system 200 of the second embodiment, the schedule management module 70 is provided in the charging station 10 as illustrated in FIG. 7. Specifically, the station control unit 38 in the second embodiment functions as the charging control module 42 and functions as the schedule management module 70 as well by executing programs. The host unit 16 is not required to be installed in the charging system 200 of the second embodiment.

The schedule management module 70 in the second embodiment can create a charging schedule (special charging schedule) having the same contents as in the first embodiment in which the schedule management module 70 is provided in the host unit 16.

As in the first embodiment, the charging station 10 of the second embodiment can accordingly finish charging of the one of the vehicles 12 early, with a power consumption amount at the charging station 10 kept from increasing.

As in the first embodiment, the schedule management module 70 in the second embodiment may demand the required payment price from one of the vehicles 12 that requests early start of charging, and may present the compensation/reward to the vehicles 12 that are reduced in future electric power charge amount.

The embodiments have been described above with reference to the attached drawings, but it should be understood that the present disclosure is not limited to the embodiments described above. It is apparent that those skilled in the art may arrive at various alternation examples and modification examples within the scope of claims, and those examples are construed as naturally falling within the technical scope of the present disclosure.

For example, in the embodiments, a charging request is issued via the user interface 54 of each of the terminal devices 14. However, a charging request may be issued via the user interface 36 of the charging station 10. A charging request may also be issued via an in-vehicle device such as a navigation device of each of the vehicles 12.

In the embodiments, the special charging schedule is automatically applied after the compensation/reward is presented to each SOC reduction target vehicle. This is because an intent to approve reduction of the SOC has been expressed in advance, prior to the start of charging. However, the schedule management module 70 may confirm once more the intent to approve reduction of the SOC at the time when the compensation/reward is presented to the SOC reduction target vehicle. According to this mode, for example, the driver of the SOC reduction target vehicle can reconsider whether to cooperate in the reduction of the future electric power charge amount by comparing the SOC at the end of charging and the compensation/reward. In this mode, when cooperation is canceled after the compensation/reward is presented, SOC reduction target vehicles may be determined anew.

What is claimed is:

1. A charging system, comprising:
one or a plurality of charging stations; and
a host unit configured to hold communication to and from the one or the plurality of charging stations,
wherein each of the one or the plurality of charging stations includes:
a plurality of chargers configured to charge batteries mounted to vehicles; and
a charging control module configured to control charging by the plurality of chargers in accordance with a charging schedule,
wherein the host unit includes a schedule management module configured to create the charging schedule, and
wherein the schedule management module is configured to:
create the charging schedule in which at least part of a future electric power charge amount planned to be allocated to some of the vehicles that are presently being charged is cut down to be allocated to charging for one of the vehicles that requests early start of charging;
demand the one of the vehicles that requests early start of charging to pay a price required to benefit from the early start of charging; and
present the some of the vehicles for which the future electric power charge amount is cut down with a compensation for inconveniences caused by the cutting down of the electric power charge amount.

2. A charging station, comprising:
a plurality of chargers configured to charge batteries mounted to vehicles;
a charging control module configured to control charging by the plurality of chargers in accordance with a charging schedule; and
a schedule management module configured to create the charging schedule,
wherein the schedule management module is configured to:
create the charging schedule in which at least part of a future electric power charge amount planned to be allocated to some of the vehicles that are presently being charged is cut down to be allocated to charging for one of the vehicles that requests early start of charging;
demand the one of the vehicles that requests early start of charging to pay a price required to benefit from the early start of charging; and
present the some of the vehicles for which the future electric power charge amount is cut down with a compensation for inconveniences caused by the cutting down of the electric power charge amount.

3. A charging system, comprising:
one or a plurality of charging stations; and
a host unit configured to hold communication to and from the one or the plurality of charging stations,
wherein each of the one or the plurality of charging stations includes:
a plurality of chargers configured to charge batteries mounted to vehicles; and
a charging control module configured to control charging by the plurality of chargers in accordance with a charging schedule,
wherein the host unit includes a schedule management module configured to create the charging schedule, and
wherein the schedule management module is configured to:
create the charging schedule in which at least part of a future electric power charge amount planned to be allocated to some of the vehicles that are presently being charged is cut down to early finish charging for one of the vehicles that requests early finish of charging;
demand the one of the vehicles that requests early finish of charging to pay a price required to benefit from the early finish of charging; and
present the some of the vehicles for which the future electric power charge amount is cut down with a compensation for inconveniences caused by the cutting down of the electric power charge amount.

4. A charging station, comprising:
a plurality of chargers configured to charge batteries mounted to vehicles;
a charging control module configured to control charging by the plurality of chargers in accordance with a charging schedule; and
a schedule management module configured to create the charging schedule,
wherein the schedule management module is configured to:
create the charging schedule in which at least part of a future electric power charge amount planned to be allocated to some of the vehicles that are presently being charged is cut down to early finish charging for one of the vehicles that requests early finish of charging;
demand the one of the vehicles that requests early finish of charging to pay a price required to benefit from the early finish of charging; and
present the some of the vehicles for which the future electric power charge amount is cut down with a compensation for inconveniences caused by the cutting down of the electric power charge amount.
